(19) United States
(12) Patent Application Publication
(10) Pub. No.: US 2024/0102189 A1
(43) Pub. Date: Mar. 28, 2024

(54) SEPARATOR PLATE, BIPOLAR PLATE, ELECTROLYZER, AND CORRESPONDING TOOLING

(71) Applicant: Reinz-Dichtungs-GmbH, Neu-Ulm (DE)

(72) Inventors: Jonas LEISCHER, Neu-Ulm (DE); Christoph SPECHT, Neu-Ulm (DE); Stephan WENZEL, Pfaffenhofen (DE); Hans WALDVOGEL, Krumbach (DE); Wilhelm KUHN, Tomerdingen (DE); Oliver CLAUS, Laichingen (DE); Franz SCHWEIGGART, Pfaffenhofen (DE)

(21) Appl. No.: 18/473,034

(22) Filed: Sep. 22, 2023

(30) Foreign Application Priority Data
Sep. 23, 2022 (DE) 20 2022 105 364.2

(51) Int. Cl. C25B 13/02; B21D 37/10; C25B 11/036; C25B 13/05

(52) U.S. Cl. CPC C25B 13/02; B21D 37/10; C25B 11/036; C25B 13/05

(57) ABSTRACT

A separator plate for an electrochemical system, an electrolyzer, a bipolar plate comprising such a separator plate, an electrolyzer comprising such a separator plate, and to tooling for producing such a separator plate. The separator plate comprising a flow area having a plurality of integrally formed support structures. An outer contour of the support structures in each case comprises: a first circular arc-shaped portion and a second circular arc-shaped portion, wherein a circular arc center point of the first circular arc-shaped portion and a circular arc center point of the second circular arc-shaped portion are arranged at a distance from each other on a longitudinal axis of the respective sup-port structure, and a joining portion which joins together the first circular arc-shaped portion and the second circular arc-shaped portion, wherein a width of the joining portion is smaller than a diameter of the first and/or second circular arc-shaped portion.

### CROSS-REFERENCE TO RELATED APPLICATION

The present application claims priority to German Utility Model Application No. 20 2022 105 364.2, entitled “SEPARATOR PLATE, BIPOLAR PLATE, ELECTROLYZER, AND CORRESPONDING TOOLING”, and filed Sep. 23, 2022. The entire contents of the above-listed application is hereby incorporated by reference for all purposes.

### TECHNICAL FIELD

The present disclosure relates to a separator plate for an electrochemical system, for instance an electrolyzer, to a bipolar plate comprising such a separator plate, to an electrolyzer comprising such a separator plate, and to tooling for producing such a separator plate.

### BACKGROUND AND SUMMARY

Electrolyzers produce, for example, hydrogen and oxygen from water by applying a potential and may at the same time compress at least one of the gases produced.

Conventional electrolyzers comprise a stack of individual cells which each comprise a sequence of layers including a separator plate, two media diffusion structures, such as porous transport layer(s) (PTL(s)) and/or gas diffusion layer(s) (GDL(s)), and a membrane electrode assembly (MEA).

This stack of electrochemical cells must be sealed off from the exterior since the media are guided within the cells at an overpressure relative to the outside pressure. To this end, electrolyzers typically have, for each of the individual electrochemical cells stacked one above the other to form an electrolyzer, a cell frame extending around the outer edge of the electrochemical cell. The individual cells in the stack are pressed together, for example by means of screws, between two end plates. The stack of electrochemical cells has sealing elements between the individual cell frames or between the cell frames and the separator plates or membrane electrode assemblies arranged between the cell frames, which sealing elements extend along the outer circumference, but at a distance inward from the outer circumference.

The individual cells which are brought together to form the stack are each separated by the separator plate, which serves on the one hand to separate the media and on the other hand to transmit the current or voltage from individual cell to individual cell, for instance due to the possibly indirect contact of the webs between the fluid-guiding channels to the MEAs. The separator plates have on their surface a flow area with a pattern of support structures, which are arranged to form channel structures for supplying and discharging fluid.

It is known to form the channel structures integrally in the separator plates. Usually, a boundary wall which separates the flow area from the surrounding area is also integrally formed. The boundary wall is designed, for example, in the form of a bead, for example in the form of a full bead or a half bead.

The channel structures have the task of ensuring an even distribution of media. Comparatively high structures which enable a suitable channel depth may assist in even distribution. However, material thinning that occurs during the embossing process limits the achievable height of the support structures.

In the case of manufacture by integral forming, a die and a corresponding punch are required. The die is typically produced by milling. In this case, the die must be dimensioned such that negatives of the support structures are stable enough to withstand forces that occur during a forming process. The support structures must therefore be designed in such a way as to ensure that the associated dies can be produced. Typical forming processes which are suitable include embossing such as vertical or roller embossing, deep-drawing or hydroforming.

Furthermore, the support structures serve to stabilize the separator plate and are intended to prevent or at least reduce bending of the separator plate.

Known support structures are typically oval or circular, and in the case of metal separator plates are typically created by forming, or also by milling in the case of small quantities, or by compression molding in the case of graphite separator plates, or by master molds in the separator plate in the case of composite separator plates. Oval or circular support structures have the disadvantage that a distance between the individual support structures is so large in some areas that a flexible layer, such as a membrane, which is arranged on the support structure sags. As a result, the membrane could become damaged, or the channel cross-section could be narrowed.

Proceeding from this prior art, the problem addressed by the present disclosure is therefore that of proposing a separator plate with improved support structures, which takes into account the above requirements and may overcome or at least improve at least one of the disadvantages in the prior art.

This problem may be addressed by embodiments described herein.

The proposed separator plate may be suitable for an electrochemical system, for example an electrolyzer or a fuel cell. The separator plate comprises a flow area for guiding media along a first flat side of the separator plate, the flow area having a large number of integrally formed, for example embossed, support structures in order to form flow channels.

An outer contour of the support structures in each case comprises:
a first circular arc-shaped portion and a second circular arc-shaped portion, wherein a circular arc center point of the first circular arc-shaped portion and a circular arc center point of the second circular arc-shaped portion are arranged at a distance from each other on a longitudinal axis of the respective support structure, and
a joining portion which joins together the first circular arc-shaped portion and the second circular arc-shaped portion, wherein a width of the joining portion is smaller than a diameter of the first and/or second circular arc-shaped portion.

In one exemplary embodiment of the separator plate, the outer contour of at least one, or more than one, of the support structures may comprise:
a third circular arc-shaped portion, the circular arc center point of which is arranged at a distance from the first circular arc center point and at a distance from the second circular arc center point on the longitudinal axis of the respective support structure, and
a second joining portion which joins the second circular arc-shaped portion to the third circular arc-shaped portion, wherein a width of the second joining portion is smaller than a diameter of the first and/or second and/or third circular arc portion.

For instance, a distribution of media across the surface can be improved by the support structures according to the present disclosure. Furthermore, a maximum distance between the respective support structures can be minimized. In the flow area, a maximum surface area in which no support structure is provided may be minimized so as to reduce any sagging of a membrane arranged thereon, or of a subsequent layer, such as a media diffusion structure.

In one embodiment of the separator plate, the diameter of the first circular arc-shaped portion may be substantially equal to the diameter of the second circular arc-shaped portion and optionally substantially equal to the diameter of the third circular arc-shaped portion. A symmetrical shape of the support structures can thus be achieved. This can improve the distribution properties of the support structures and also the supporting effect of the support structures. At least in some areas, the support structures may be distributed symmetrically and/or substantially evenly in the flow area. In the context of this document, a substantially equal diameter of the circular arc-shaped portions will be understood to mean diameters which differ by at most 15%, by at most 10%, by at most 5%, for instance by at most 2%.

In one embodiment of the separator plate, the support structures may be designed in such a way that the outer contour of the respective support structure tapers symmetrically, and for instance smoothly, in the first joining portion between the first and the second circular arc-shaped portion, and/or the outer contour of the respective support structure tapers symmetrically, and for instance smoothly, in the second joining portion between the second and the third circular arc-shaped portion.

A symmetrical and/or smooth outer contour of the support structures can improve the flow properties of the flow area, for example can reduce turbulence and/or areas of blockage.

In one embodiment of the separator plate, some or all of the support structures may be designed in such a way that a minimum width of the first joining portion and/or second joining portion is equal to or greater than the radius of the first and/or second and/or third circular arc-shaped portion. In addition or as an alternative, some or all of the support structures may be designed in such a way that a minimum width of the first joining portion and/or second joining portion is less than 80%, less than 70%, less than 60% of the diameter of the first and/or second and/or third circular arc-shaped portion. The minimum width of the first and/or second and/or third joining portion may be measured at a lower end of the respective support structure, e.g. at the end bearing against the base surface of the separator plate. The diameter and/or radius of the first and/or second and/or third circular arc-shaped portion may be measured at the lower end of the respective support structure.

Such an embodiment can improve a substantially even arrangement of the support structures in the flow area.

In one embodiment of the separator plate, some or all of the support structures may be designed in such a way that a minimum distance between the circular arc center point of the first circular arc-shaped portion and the circular arc center point of the second circular arc-shaped portion and/or a minimum distance between the circular arc center point of the second circular arc-shaped portion and the circular arc center point of the third circular arc-shaped portion is greater than 130%, greater than 150%, for example greater than 155% of the diameter of the first and/or second and/or third circular arc-shaped portion.

In one embodiment of the separator plate, some or all of the support structures may be designed in such a way that a minimum distance between the circular arc center point of the first circular arc-shaped portion and the circular arc center point of the second circular arc-shaped portion and/or a minimum distance between the circular arc center point of the second circular arc-shaped portion and the circular arc center point of the third circular arc-shaped portion is less than 180%, less than 170%, for instance less than 160% of the diameter of the first and/or second and/or third circular arc-shaped portion.

Such an embodiment can improve a substantially even arrangement of the support structures in the flow area and/or can improve an even distribution of a medium in the flow area.

In one embodiment of the separator plate, some or all of the support structures may be designed in such a way that the support structures have at their most tapered point a wall thickness of at least 30%, at least 50%, at least 60%, for instance at least ⅔ of the original sheet thickness, as can be measured in undeformed regions of the finished separator plate.

Typical sheet thicknesses of the separator plates are at least 0.15 mm, at least 0.2 mm, at least 0.3 mm, at least 0.4 mm and/or at most 0.8 mm, at most 0.6 mm, for instance at most 0.5 mm.

Such an embodiment of the support structures may have the advantage that they can be comparatively stable and can withstand a pressure prevailing in an electrochemical system. A suitable die, which is required for integrally forming such support structures, can be produced by means of milling, for example.

In one embodiment of the separator plate, the support structures may be arranged and designed in such a way that, in the flow area, a surface area in which no support structure is arranged can be described by a maximum circle enclosed in said surface area and having a radius of at least 0.75 mm, at least 0.8 mm, at least 0.9 mm, for instance at least 1 mm and/or at most 1.3 mm, at most 1.2 mm, for example at most 1.1 mm. The radius may be measured at the upper end of the support structures. The upper end may be the end located at the greatest distance from the base surface of the separator plate. However, it is also possible—for example, but not only, if the support structures have a slight curvature in the upward direction—that the measurement may take place slightly below the farthest projecting point, for example 0.02 mm below the farthest projecting point of the support structures located closest to each other. A flexible layer arranged on at least one of the support structures can thus be supported by the support structure; for example, sagging in the unsupported areas can be prevented or at least reduced. The flexible layer may be a membrane.

In one embodiment of the separator plate, some or all of the support structures may be arranged and designed in such a way that they taper from their lower end to their upper end. A base surface of the respective support structure may therefore be larger at its lower end, arranged on the base surface of the separator plate, than at its upper end, located at the greatest distance from the base surface of the separator plate.

In one embodiment of the separator plate, flow channels formed by the support structures may have a depth of at least 0.2 mm, at least 0.3 mm, such as at least 0.4 mm and/or may have a depth of at most 0.9 mm, at most 0.6 mm, such as at most 0.5 mm. The depth may be measured along an axis between the lower end of the respective support structure, which bears against the base surface, and an upper end thereof, which is located at the greatest distance from the base surface, said axis being perpendicular to the base surface of the separator plate.

This comparatively large depth can improve the distribution of media. The above-described shape of the support structures can ensure that such a described depth does not lead to cracking of the material during the forming process.

In one embodiment of the separator plate, the support structures may be arranged and designed in such a way that the flow channels formed by the support structures have a width of at least 0.4 mm, at least 0.5 mm, such as at least 0.6 mm and/or have a width of at most 1.4 mm, at most 1.2 mm, such as at most 1.0 mm. The width of the flow channels may be defined by a minimum distance, halfway up the flow channels, between two respective support structures arranged directly adjacent to each other. Here, directly adjacent can be understood to mean that the support structures are arranged directly adjacent in a row, e.g. they have the same longitudinal axis. When measured at the ground of the channels, thus the lowest area of the support structures, the flow channels formed by the support structures have a width of at least 0.5 mm, at least 0.6 mm, at least 0.8 mm and/or have a width of at most 2.4 mm, at most 2.3 mm, at most 2.2 mm. Two support structures which are arranged in two different rows, e.g. their longitudinal axes extend parallel to each other, can also be directly adjacent. For instance, two support structures which are arranged directly adjacent can be understood to mean that no further support structure is arranged between the two directly adjacent support structures. For instance, a minimum distance between any two directly adjacent support structures may be the same in each case.

In one embodiment of the separator plate, the support structures in the flow area may be arranged in such a way that multiple support structures are arranged at a distance from each other in a row substantially on a common longitudinal axis. In the context of this document, the support structures in the flow area are considered to be arranged substantially on a common longitudinal axis if their longitudinal axes are shifted relative to each other by at most 15%, by at most 10%, by at most 5%, by at most 2% of the diameter of one of the circular arcs, such as of the largest of the respective circular arcs of the respective support structure.

In one embodiment of the separator plate, the support structures in the flow area may be arranged in such a way that multiple support structures are arranged at a distance from each other in a row on substantially parallel longitudinal axes. In the context of this document, the support structures in the flow area are considered to be arranged on substantially parallel longitudinal axes if their longitudinal axes extend at a minimal angle relative to each other, said angle being at most ±15°, at most ±10°, at most ±5°, such as at most ±2°.

In one embodiment of the separator plate, the support structures in the flow area may be arranged in such a way that the first support structures arranged on a first longitudinal axis and forming a first row are arranged offset from the second support structures arranged on a second longitudinal axis and forming a second row, said second longitudinal axis extending parallel to the first longitudinal axis.

It is thus possible to arrange the support structures at optimized distances which are as constant as possible. This may also have the advantage that the separator plate is comparatively stiff with regard to bending.

The support structures may thus be arranged in multiple rows arranged adjacent to each other. In this case, the longitudinal axes of the support structures of adjacently arranged rows may extend parallel to each other. The support structures of a row may have the same longitudinal axis. A minimum distance between adjacent support structures in a row may be constant. The minimum distance between adjacent support structures of the same row may be measured along the longitudinal axis of the support structures. A distance between adjacent rows of support structures may be constant throughout the flow area, with the distance between two rows being defined as a minimum distance between the longitudinal axis of the support structures of a first row and the longitudinal axis of the support structures of a second row. The support structures may be designed and arranged in such a way that a minimum distance between a first support structure of a first row and a second, adjacent support structure of a second row adjacent to the first row is the same for all the support structures in the flow area.

The flow area may have a circular, square, rectangular or oval shape, or it may have a shape corresponding to a combination of some of these shapes. A rectangular or square shape may have convenient stackability and easier transportation of separator plates, or of bipolar plates comprising same, as yet to be explained below, and/or of corresponding electrochemical systems comprising the separator plates.

The separator plate may have openings for supplying and discharging media.

The separator plates typically comprise metal, graphite or carbon composites.

The present disclosure further relates to a bipolar plate comprising a separator plate according to the above description. The bipolar plate may comprise a further separator plate designed according to the above description, e.g. a total of two such separator plates. Alternatively, the bipolar plate may comprise one separator plate designed according to the above description and a further separator plate designed differently therefrom. The further separator plate may have support structures which form straight channels extending parallel to each other. The support structures may form elongated ribs which extend parallel to each other. The ribs may have the same length or different lengths. The separator plates of the bipolar plate may be pressed flat against each other in part. In the assembled state, the longitudinal axes of the rib structures may extend transversely to the longitudinal axes of the support structures of the above-described separator plate.

The present disclosure further relates to an electrolyzer comprising at least one separator plate according to the above description and/or a bipolar plate according to the above description.

The electrolyzer typically has, for each of the individual electrochemical cells stacked one above the other to form the electrolyzer, a cell frame extending around the outer edge of the electrochemical cell. The individual cells in the stack are typically pressed together, for example by means of screws, between two end plates. The stack of electrochemical cells may have sealing elements between the individual cell frames or between the cell frames and the separator plates or membrane electrode assemblies arranged between the cell frames, which sealing elements extend along the outer circumference, but at a distance inward from the outer circumference. Here, “between” does not exclude the situation where the sealing elements, at least to a part of their height in the stacking direction, are received in one of the aforementioned elements. The individual cells which are brought together to form the stack may therefore be separated by the respective separator plate.

The present disclosure further comprises tooling for producing a separator plate according to the above description, the tooling comprising a die and a punch. The die typically has a region that corresponds to a negative of a first surface of the above-described separator plate with the described support structures. The negative forms of the support structures on the die may be produced by milling. The punch may have a region that corresponds to a negative of a second surface of the above-described separator plate with the described support structures. By using the die and the punch, the above-described support structures can be integrally formed in the separator plate. Such a forming process is well known to a person skilled in the art and therefore will not be described in any greater detail here.

Examples of a separator plate according to the present disclosure and of electrochemical cells and of electrolyzers according to the present disclosure will be given below.

Identical and similar reference signs will be used for identical and similar elements and therefore these may not be repeatedly described.

In addition to the essential features of the present disclosure, the examples explained below with reference to the appended figures each contain a plurality of optional features which, individually or in combination, may further develop the present disclosure. Features from different examples can be combined with each other.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an exploded view of an individual cell of an electrolyzer comprising a separator plate according to the present disclosure,

FIG. 2A shows a plan view of the separator plate forming the anode of the individual cell according to FIG. 1,

FIG. 2B shows a sectional view of the section A-A, labeled in FIG. 2A, through the separator plate of the anode,

FIG. 2C shows a sectional view of the section B-B, labeled in FIG. 2A, through the separator plate of the anode,

FIG. 3A shows a plan view of the separator plate forming the cathode of the individual cell according to FIG. 1,

FIG. 3B shows a detail from a sectional view of the section A′-A′, labeled in FIG. 3A, through the separator plate of the cathode,

FIG. 3C shows a detail from a sectional view of the section B′-B′, labeled in FIG. 3A, through the separator plate of the cathode,

FIG. 3D shows a detail C, labeled in FIG. 3A, from the plan view of the separator plate,

FIG. 3E shows a detail D, labeled in FIG. 3A, from the plan view of the separator plate,

FIG. 4A shows a detail from a perspective view of a punch for producing a separator plate according to FIGS. 3A to 3E,

FIG. 4B shows a detail from a plan view of a punch for producing a separator plate according to FIGS. 3A to 3E,

FIG. 5 shows a detail from a perspective view of a die for producing a separator plate according to FIGS. 3A to 3E,

FIG. 6A shows a plan view of a separator plate forming the cathode of the individual cell in an alternative embodiment,

FIG. 6B shows a plan view of a separator plate forming the cathode of the individual cell in another alternative embodiment,

FIG. 7 shows the cell frame of FIG. 1 with water ports for supplying and discharging water, in a perspective view, and

FIG. 8 shows the cell frame of FIG. 1 with hydrogen ports for supplying and discharging hydrogen, in a perspective view.

### DETAILED DESCRIPTION

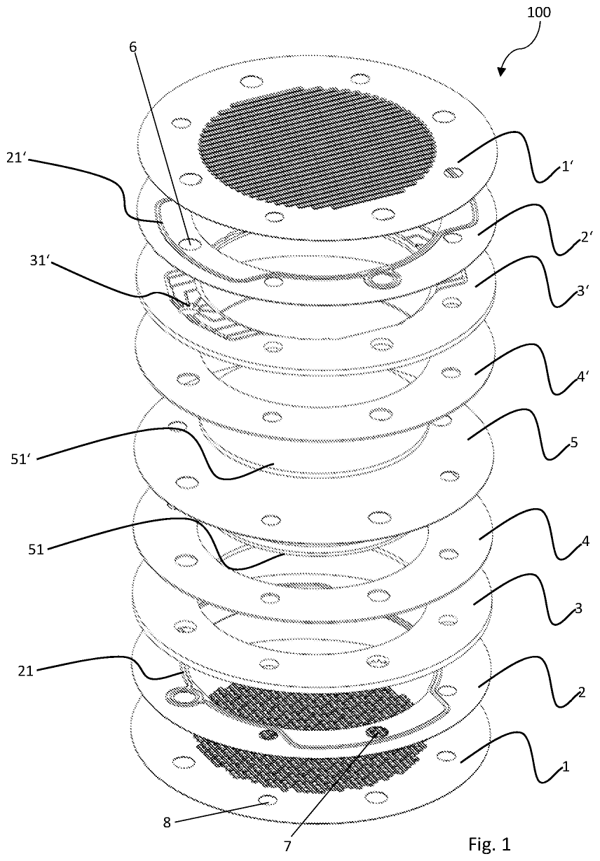

FIG. 1 shows an exploded view of an individual cell 100 of an electrolyzer. The individual cell 100 comprises two separator plates 1 and 1′, two cell frames 3 and 3′, sealing layers 2, 4, 2′ and 4′, and a membrane electrode assembly 5 with media diffusion structures 51 and 51′. By way of example, the media diffusion structure 51 comprises layers of carbon fleece, while the media diffusion structure 51′ comprises metal, e.g. titanium. The separator plate 1 is arranged on the cathode side of the individual cell 100. The separator plate 1′ is arranged on the anode side of the individual cell 100. The individual layers are pressed together to form an individual cell. The individual layers each have mutually aligned water ports 6 for supplying and discharging water and oxygen, hydrogen ports 7 for supplying and discharging hydrogen, and positioning holes 8. The system is usually flooded with hydrogen in the corresponding flow areas prior to commissioning. A flow area of the separator plate 1′ is defined by projecting the circumferential seal 21′ onto the separator plate P. A flow area of the separator plate 1 is defined by projecting the circumferential seal 21 onto the separator plate 1. The cell frame 3′ has distribution channels 31′ for distributing the supplied water. When a potential is applied, hydrogen can be produced from the supplied water.

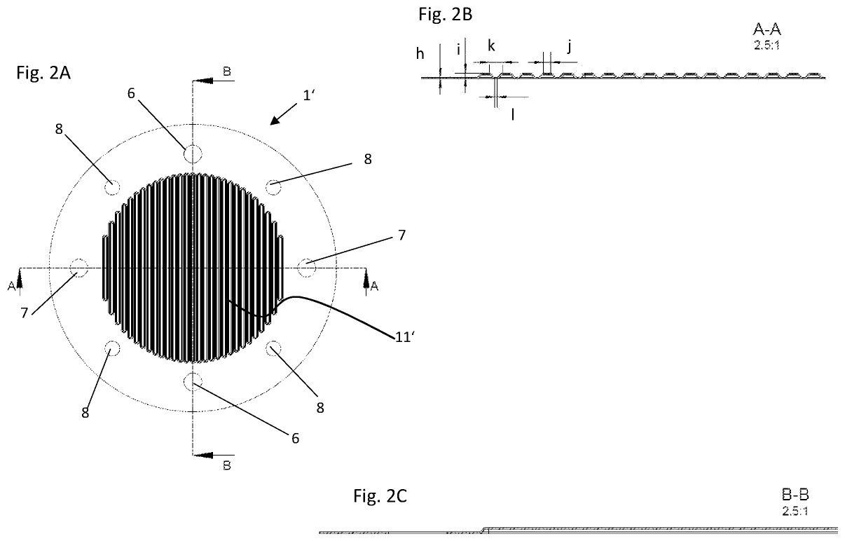

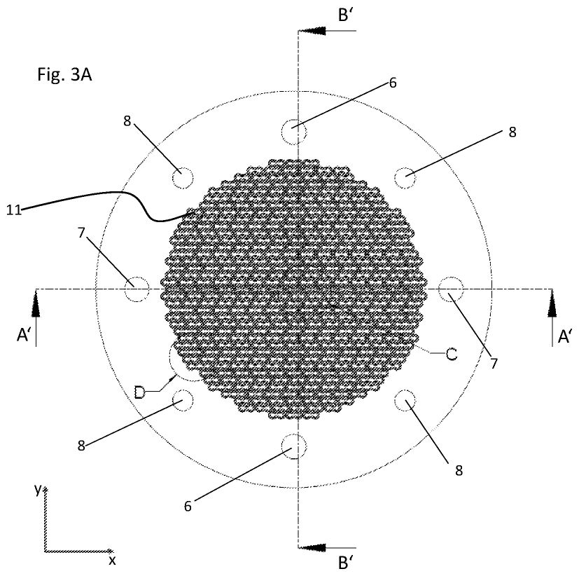

FIG. 2A shows the separator plate 1′ in a plan view. The separator plate 1′ is formed of a metal sheet having a sheet thickness h of 0.2 mm. Rib-shaped support structures 11′ are integrally formed in the separator plate. The rib-shaped support structures 11′ have a straight, elongated shape and are arranged in parallel next to each other. The rib-shaped support structures 11′ are wider at their lower end, which is arranged on the base surface of the separator plate 1′, than at their upper end, which is located at the greatest distance from the base surface of the separator plate 1′. In the present example, the rib-shaped support structures 11′ have a constant width j of 1.4 mm at their upper end, specifically 0.02 mm below the farthest projecting region. The rib-shaped support structures 11′ have a height i of 0.7 mm. Between rib-shaped support structures 11′ which extend directly adjacent to each other, channels are formed which have, for example, a width k of 2.0 mm, the width k being measured 0.02 mm below the upper end of the rib-shaped support structures 11′. In the present example, the channels have a width 1 of 0.3 mm at their lower end. The values specified are example values. For instance, in a different example, a separator plate 1′ may have substantially the same ratios, but may be larger or smaller than the example above. The values in such an exemplary embodiment may therefore be substantially a multiple of the values specified by way of example above.

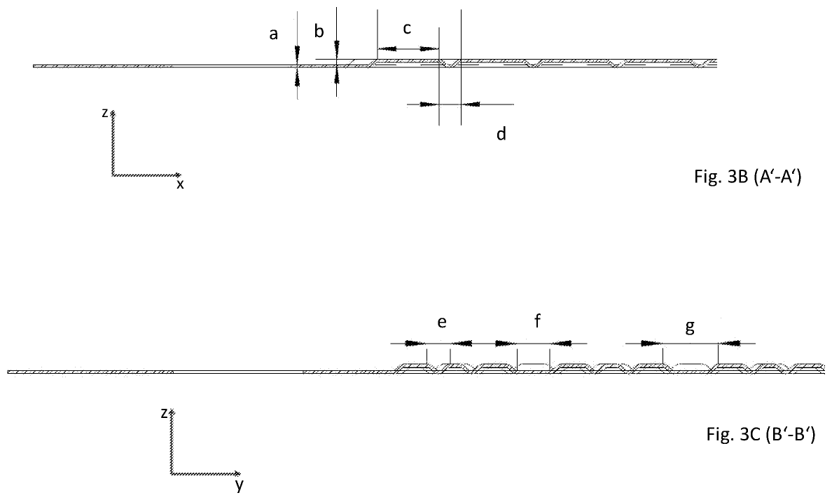

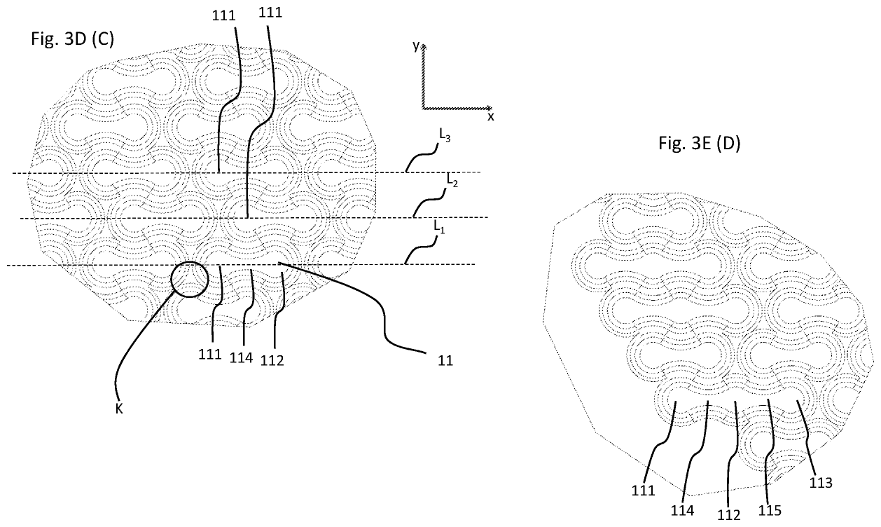

FIG. 3A shows the separator plate 1 of FIG. 1 in a plan view. The separator plate 1 is made of a metal sheet having a sheet thickness a of 0.2 mm (cf. FIG. 3B). A large number of support structures 11 are integrally formed in the separator plate 1.

FIG. 3D shows the detail C, which is labeled in FIG. 3A, in an enlarged view. As an example, one of the support structures is provided with the reference sign 11. The support structures 11 each comprise a first circular arc-shaped portion 111 having a first diameter and a second circular arc-shaped portion 112 having a second diameter. The first diameter is equal to the second diameter. A circular arc center point of the first circular arc-shaped portion 111 and a circular arc center point of the second circular arc-shaped portion 112 are located at a distance from each other on a common longitudinal axis L₁ of the support structure 11. The longitudinal axis L₁ extends parallel to the x-axis of the coordinate system shown in FIG. 3D. Here, the x-axis extends in a horizontal direction with respect to the image plane, the y-axis extends in a vertical direction with respect to the image plane, and the z-axis points perpendicularly out of the image plane. The support structures 11 each comprise a joining portion 114. A width of the joining portion 114, e.g. an extent of the joining portion along the y-axis, is smaller than the diameter of the first circular arc-shaped portion 111. In the plan view (as shown, for example, in FIGS. 3A, 3D and 3E), the outer contour of the respective support structure 11 tapers symmetrically in the first joining portion 114 between the first and the second circular arc-shaped portion 111, 112.

The support structures 11 of the separator plate 1 are arranged in rows which extend parallel to each other. Therefore, any two support structures 11 of the separator plate either have the same longitudinal axis (and are therefore arranged in one row) or have a longitudinal axis extending in parallel (and are therefore arranged in different rows). The pattern formed by the support structures will be described below by way of example on the basis of three adjacent rows. Multiple support structures 11 are arranged at a distance from each other on the longitudinal axis L₁ in a first row, with all the support structures of this row having the same longitudinal axis L₁. Directly adjacent to the support structures 11 of the first row, multiple support structures 11 are arranged on the longitudinal axis L₂ so as to form a second row, with all the support structures 11 of this second row having the same longitudinal axis L₂. Directly adjacent to the support structures 11 of the second row, multiple support structures 11 are arranged on the longitudinal axis L₃ so as to form a third row, with all the support structures 11 of this third row having the same longitudinal axis L₃. The longitudinal axes L₁, L₂ and L₃ are arranged parallel to each other and spaced apart from each other by the same distance, so that the rows of support structures are likewise arranged parallel to each other and spaced apart from each other. For instance, the support structures of one row are arranged offset from the support structures of a directly adjacent row. A straight line through the circle center point of the first circular arc-shaped portion 111 of a support structure 11 of the first row and the circle center point of the first circular arc-shaped portion 111 of an adjacent support structure 11 of the second row are therefore not located on a straight line parallel to the Y-axis. In contrast, a straight line through the circle center point of the first circular arc-shaped portion 111 of a support structure 11 of the first row and the circle center point of the first circular arc-shaped portion 111 of a support structure 11 of the third row is parallel to the Y-axis. This pattern may stiffen the separator plate 1 and counteracts bending of the separator plate 1. Furthermore, this makes it possible to arrange the support structures at optimized distances which are as constant as possible. In the present case, a minimum distance between the longitudinal axis L₁ and the longitudinal axis L₂ is 2.6 mm. In the present case, a minimum distance between the longitudinal axis L₁ and the longitudinal axis L₃ is 5.2 mm.

Some of the support structures of the separator plate 1 comprise a third circular arc-shaped portion 113. The circular arc center point of the third circular arc-shaped portion 113 is located on the longitudinal axis of the support structure 11 and thus on the same longitudinal axis as the circle center point of the first and the second circular arc-shaped portion of the same support structure 11. In the present case, these support structures 11 comprising a third circular arc-shaped portion 113 are arranged in an edge region of the flow area, as can be seen in FIG. 3A and detail D (shown on an enlarged scale in FIG. 3E). In other exemplary embodiments, support structures comprising a third circular arc-shaped portion may be arranged in other regions of the flow area, for example in the center of the flow area. The support structures 11 comprising a third circular arc-shaped portion 113 also have a second joining portion 115 which joins the second circular arc-shaped portion 112 to the third circular arc-shaped portion 113, wherein a width of the second joining portion 115 is smaller than a diameter of the first (111) and/or second (112) and/or third circular arc portion (113). In the plan view, the outer contour of the respective support structure 11 tapers symmetrically in the second joining portion 115 between the second and the third circular arc-shaped portion 112, 113. A minimum width of the first joining portion 114 (and/or of the second joining portion 115) is equal to or greater than the radius of the first and/or second and/or third circular arc-shaped portion. In the present case, the minimum width of the first joining portion 114 is 0.9 mm. The minimum width of the second joining portion 115 is 0.9 mm. The widths are again measured 0.02 mm below the farthest projecting point.

The diameter and/or radius of the first and/or second and/or third circular arc-shaped portion 111, 112, 113 may be measured at the lower end of the respective support structure 11. A minimum distance between the circular arc center point of the first circular arc-shaped portion 111 and the circular arc center point of the second circular arc-shaped portion 112 is greater than 95% of the diameter of the first (111) and/or second (112) and/or third (113) circular arc-shaped portion. The minimum distance between the circular arc center point of the first circular arc-shaped portion 111 and the circular arc center point of the second circular arc-shaped portion 112 is less than 115% of the diameter of the first (111) and/or second (112) and/or third (113) circular arc-shaped portion. In the present case, the minimum distance between the circular arc center point of the first circular arc-shaped portion 111 and the circular arc center point of the second circular arc-shaped portion 112 is 3.15 mm. The diameter of the first (111) and second (112) and third (113) circular arc-shaped portion is in each case 3 mm, with the diameter having been measured at a lower edge of the support structure 11.

The support structures 11 are arranged and designed in such a way that, in the flow area, a radius of a maximum circular surface area K formed between the support structures and in which no support structure is arranged is at least 0.7 mm, at least 0.8 mm, at least 0.9 mm and/or at most 1.3 mm, at most 1.2 mm, for instance at most 1.1 mm. In the present example, the radius is 1.0 mm. The radius is measured at the upper end of the support structures 11. The upper end is the end located at the greatest distance from the base surface of the separator plate. At a point 20 μm below the upper end, the corresponding radius is 0.9 mm. The ranges are, for example, 0.1 mm below the aforementioned limits. A flexible layer arranged on the support structures can thus be supported by the support structures; for instance, sagging in the unsupported regions can be prevented or at least reduced.

The support structures have at their most tapered point a wall thickness of at least 30%, at least 50%, at least 60%, such as at least ⅔ of the original sheet thickness, as can be measured in undeformed regions of the finished separator plate.

The support structures 11 are arranged and designed in such a way that flow channels formed by the support structures have a width of at least 0.4 mm, at least 0.5 mm, at least 0.6 mm and/or have a width of at most 1.4 mm, at most 1.2 mm, such as at most 1.0 mm. This width is measured halfway up the support structures. When measured at the ground of the channels, thus the lowest area of the support structures, the flow channels formed by the support structures have a width of at least 0.5 mm, at least 0.6 mm, at least 0.8 mm and/or have a width of at most 2.4 mm, at most 2.3 mm, at most 2.2 mm.

FIG. 3B shows a detail from a sectional view of the section A′-A′, labeled in FIG. 3A, through the separator plate 1 of the cathode. In the present case, a channel depth b is 0.4 mm, the sheet thickness a in the undeformed region is 0.2 mm. A maximum extent c of the support structure 11 along the longitudinal axis L, measured at the upper end of the support structure 11, is 4.6 mm, and at a point 20 μm below the upper end is 4.9 mm. A maximum distance d between two directly adjacent support structures 11 along the longitudinal axis L, measured at the upper end of the support structure 11, is 1.6 mm, and at a point 20 μm below the upper end is 1.3 mm. The values specified are example values. For instance, in a different example, a separator plate 1 may have substantially the same ratios, but may be larger or smaller than the example above. The values in such an exemplary embodiment may therefore be substantially a multiple of the values specified by way of example above.

FIG. 3C shows a detail from a sectional view of the section B′-B′, labeled in FIG. 3A, through the separator plate 1 of the cathode. In the present case, a distance e between a support structure 11 of a first row and a support structure 11 of a directly adjacent second row is 1.5 mm.

The distance e is measured at an upper side of the support structures 11 along a straight line parallel to the y-axis that extends through a circle center point of the first circular arc-shaped portion 111 of the support structure of the first row. At a point 20 μm below the upper end, the corresponding value is 1.2 mm.

In the present case, a distance f between a support structure 11 of a first row and a support structure 11 of a third row is 2.1 mm. The distance f is measured at a lower end of the support structures 11 along a straight line parallel to the y-axis that extends through the circle center point of the first circular arc-shaped portion 111 of the support structure of the first row and the circle center point of the first circular arc-shaped portion 111 of the support structure 11 of the third row.

In the present case, a distance g between a support structure 11 of a first row and a support structure 11 of a third row is 3.6 mm. The distance g is measured at an upper end of the support structures 11 along a straight line parallel to the y-axis that extends through the circle center point of the first circular arc-shaped portion 111 of the support structure of the first row and the circle center point of the first circular arc-shaped portion 111 of the support structure 11 of the third row. At a point 20 μm below the upper end, the corresponding value is 3.3 mm.

The values specified are example values. For instance, in a different example, a separator plate 1 may have substantially the same ratios, but may be larger or smaller than the example above. The values in such an exemplary embodiment may therefore be substantially a multiple of the values specified by way of example above.

The separator plates shown in the groups of FIGS. 2A-2C and 3A-3E, namely the separator plate of the anode on the one hand and the separator plate of the cathode on the other hand, can be joined together and thus form a bipolar plate. By way of example, a welded joint could be formed in the region defined by the distance f.

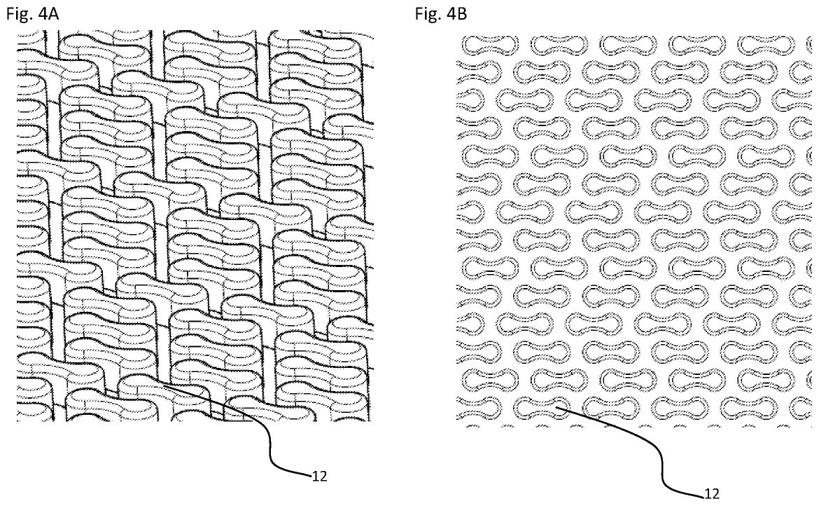

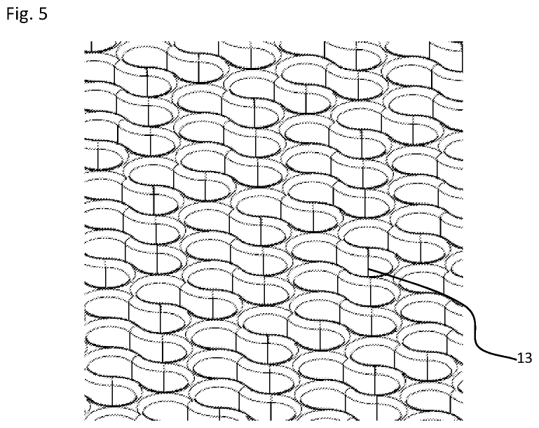

FIGS. 4A and 4B show details of a punch for producing the separator plate 1 according to FIG. 1 and FIGS. 3A to 3E. FIG. 5 shows a detail of a corresponding die. The punch is shown in a perspective view in FIG. 4A and in a plan view in FIG. 4B. The punch is designed to produce the separator plate 1 by forming, such as by embossing. To this end, a metal sheet is pressed into the die of FIG. 5 by the punch. The die has a large number of recesses 13, the shape of which substantially corresponds to an outer contour of the support structures 11 of the separator plate 1. The punch has a large number of support structure punches 12, the shape of which substantially corresponds to an inner contour of the support structures 11 of the separator plate 1. Depending on the properties of the metal sheet, however, there is deviation between the contour of the tooling and the contour of the component. The die has a wall thickness of at least 0.5 mm and at most 0.9 mm.

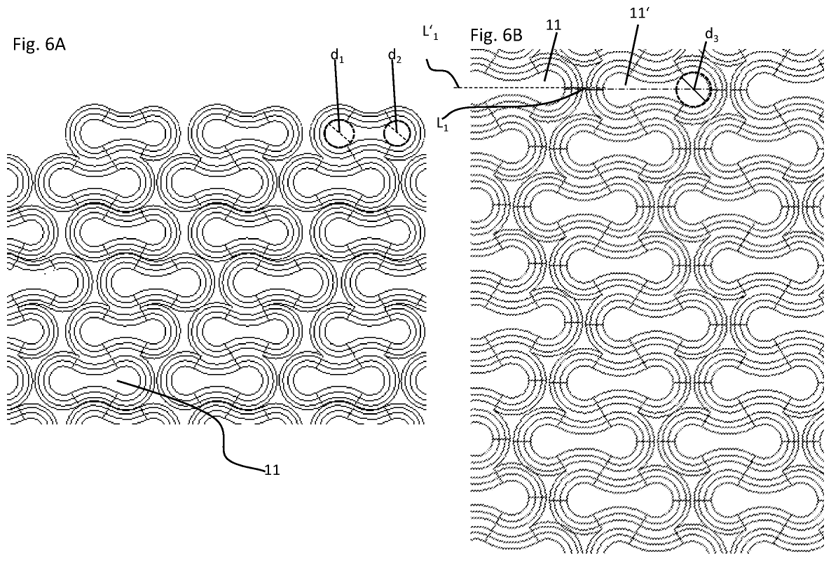

FIGS. 6A and 6B show plan views of further separator plates according to the present disclosure, similar to FIG. 3A. FIG. 6A shows a support structure 11 in which the diameter di of the first circular arc-shaped portion is substantially equal to the diameter d 2 of the second circular arc-shaped portion. It is clear from FIG. 6A that a difference of 13% between the diameters also corresponds to “substantially equal diameters” in the context of this document.

FIG. 6B shows two mutually adjacent support structures 11, 11′ located substantially on the same longitudinal axis, wherein the longitudinal axes L₁, L′₁ of the two support structures 11, 11′ are shifted by 13% of the diameter d 3 but are interpreted as substantially parallel in the context of this document.

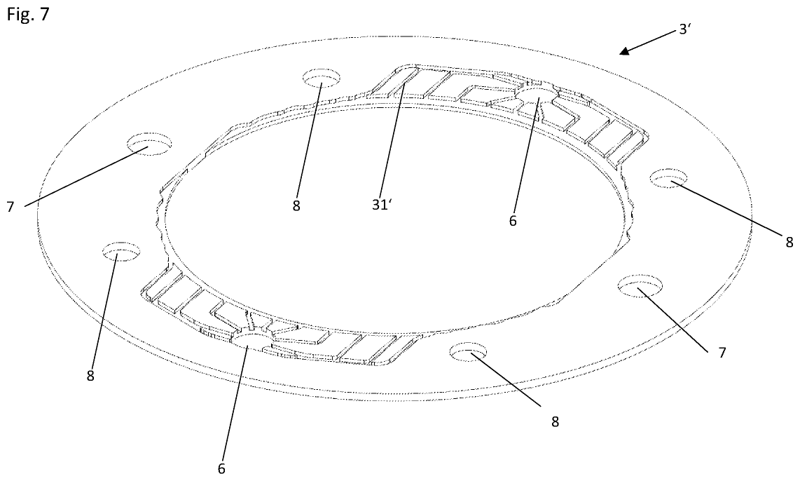

FIG. 7 shows the cell frame 3′ of FIG. 1. The cell frame 3′ has water ports 6 for supplying and discharging water and oxygen, hydrogen ports 7 for supplying and discharging hydrogen, and positioning holes 8. The cell frame 3′ has distribution channels 31′ for distributing and collecting the water and the oxygen transported therein.

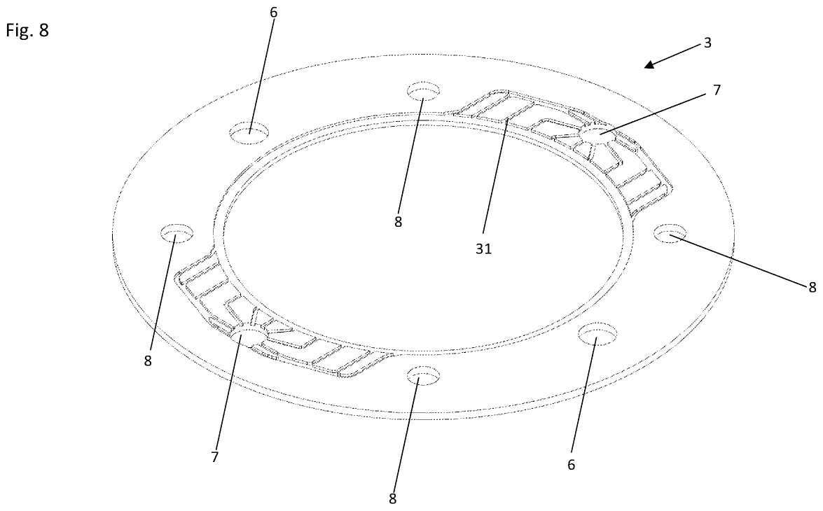

FIG. 8 shows a cell frame 3 of FIG. 1. The cell frame 3 has water ports 6 for supplying and discharging water and oxygen, hydrogen ports 7 for supplying and discharging hydrogen, and positioning holes 8. The cell frame 3 has distribution channels 31 for distributing and collecting the hydrogen.

FIGS. 1-8 are shown approximately to scale. FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” or “substantially” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A separator plate for an electrochemical system, comprising a flow area for guiding media along a first flat side of the separator plate, the flow area having a plurality of integrally formed support structures in order to form flow channels, wherein an outer contour of the support structures in each case comprises:
a first circular arc-shaped portion and a second circular arc-shaped portion, wherein a circular arc center point of the first circular arc-shaped portion and a circular arc center point of the second circular arc-shaped portion are arranged at a distance from each other on a longitudinal axis of the respective support structure, and
a joining portion which joins together the first circular arc-shaped portion and the second circular arc-shaped portion, wherein a width of the joining portion is smaller than a diameter of the first and/or second circular arc-shaped portion.

2. The separator plate according to claim 1, wherein the outer contour of at least one of the support structures comprises
a third circular arc-shaped portion, the circular arc center point of which is arranged at a distance from the first circular arc center point and at a distance from the second circular arc center point on the longitudinal axis of the respective support structure, and
a second joining portion which joins the second circular arc-shaped portion to the third circular arc-shaped portion, wherein a width of the second joining portion is smaller than a diameter of the first and/or second and/or third circular arc portion.

3. The separator plate according to claim 1, wherein the diameter of the first circular arc-shaped portion is substantially equal to the diameter of the second circular arc-shaped portion and/or substantially equal to the diameter of the third circular arc-shaped portion.

4. The separator plate according to claim 1, wherein the outer contour of the respective support structure tapers symmetrically in the first joining portion between the first and the second circular arc-shaped portion, and/or in that the outer contour of the respective support structure tapers symmetrically in the second joining portion between the second and the third circular arc-shaped portion.

5. The separator plate according to claim 1, wherein a minimum width of the first joining portion and/or second joining portion is equal to or greater than the radius of the first and/or second and/or third circular arc-shaped portion.

6. The separator plate according to claim 1, wherein a minimum width of the first joining portion and/or second joining portion is less than 80% of the diameter of the first and/or second and/or third circular arc-shaped portion.

7. The separator plate according to claim 1, wherein a minimum distance between the circular arc center point of the first circular arc-shaped portion and the circular arc center point of the second circular arc-shaped portion and/or a minimum distance between the circular arc center point of the second circular arc-shaped portion and the circular arc center point of the third circular arc-shaped portion is greater than 130% of the diameter of the first and/or second and/or third circular arc-shaped portion.

8. The separator plate according to claim 1, wherein a minimum distance between the circular arc center point of the first circular arc-shaped portion and the circular arc center point of the second circular arc-shaped portion and/or a minimum distance between the circular arc center point of the second circular arc-shaped portion and the circular arc center point of the third circular arc-shaped portion is less than 180% of the diameter of the first and/or second and/or third circular arc-shaped portion.

9. The separator plate according to claim 1, wherein the support structures have at their most tapered point a wall thickness of at least 30% of the original sheet metal thickness.

10. The separator plate according to claim 1, wherein the support structures are arranged in such a way that, in the flow area, a radius of a maximum circular surface area formed between the support structures and in which no support structure is arranged has at least 0.8 mm and/or is at most 1.3 mm.

11. The separator plate according to claim 1, wherein flow channels formed by the support structures have a depth of at least 0.2 mm and/or have a depth of at most 0.9 mm.

12. The separator plate according to claim 1, wherein the support structures are arranged in such a way that flow channels formed by the support structures at the ground of the flow channels have a width of at least 0.5 mm and/or have a width of at most 2.4 mm.

13. The separator plate according to claim 1, wherein the support structures in the flow area are arranged in such a way that multiple support structures are arranged at a distance from each other in a row substantially on a common longitudinal axis.

14. The separator plate according to claim 1, wherein the support structures in the flow area are arranged in such a way that multiple support structures are arranged at a distance from each other in a row on substantially parallel longitudinal axes.

15. The separator plate according to claim 1, wherein the first support structures arranged on a first longitudinal axis and forming a first row are arranged offset from the second support structures arranged on a second longitudinal axis and forming a second row, said second longitudinal axis extending parallel to the first longitudinal axis.

16. A bipolar plate, comprising a separator plate according to claim 1.

17. An electrolyzer, comprising at least one separator plate according to claim 1.

18. A tooling for producing a separator plate according to claim 1, the tooling comprising a die and/or a punch.
